(19) United States
(12) Patent Application Publication
(10) Pub. No.: US 2001/0034250 A1
(43) Pub. Date: Oct. 25, 2001

(54) Hand-held personal computing device with microdisplay

(76) Inventor: Sanjay Chadha, Nepean (CA)

Correspondence Address: Thomas Adams, Thomas Adams & Assoc., P.O. Box 11100, Station H, Ottawa, ON, K2H 7T8, CA

(21) Appl. No.: 09/768,007

(22) Filed: Jan. 24, 2001

Related U.S. Application Data
(60) Provisional application No. 60/177,628, filed on Jan. 24, 2000.

(51) Int. Cl. H04B 1/38

(52) U.S. Cl. 455/566; 455/90; 455/575

(57) ABSTRACT

A portable hand-held computer device comprises a base (10) and a hinged support (12A,12B,34) pivotal between a closed position lying against the base, and an open position extending perpendicularly from the base. A microdisplay (16) attached to the distal end of the support provides a virtual display measuring between, for example, 9 inches and 19 inches diagonally. The base unit (10) houses a microcomputer (90), which drives the microdisplay (16), and a mobile telephone unit (92). Controls (42,46) and a touch-sensitive pad (48) for operating the microcomputer (90) are provided on an upper face of the base (10). The touch-sensitive pad (48) may be an overlay upon a second display which is used to display mobile telephone information. Part (34) of the support carries a set of mobile telephone controls (36) for use when the device is closed and the part (34) obscures the microcomputer controls (42,46). The device may be used with a docking station (13) in a vehicle.

### DESCRIPTION

1. Technical Field

The invention relates to hand-held electronic devices, for example portable personal computers, personal digital assistants, and so on.

2. Background Art

There is a trend towards small, hand-held devices for mobile computing and/or communications. As more and more people use the Internet for more and more applications (emails, trading/monitoring investments, weather and traffic, directory enquiries, etc.), demand to access the Internet everywhere any time is expected to grow rapidly. Such growth will increase the need for hand-held devices which can access the Internet and yet be small enough to slip into a user's pocket or purse. One group of devices include hand-held computers or increasingly powerful so-called personal digital assistants (PDAs) which may be connected to a mobile telephone to access the Internet. Alternatively, recently-introduced mobile telephones may be used to access the Internet, though in a limited way. A significant disadvantage of these hand-held devices, however, is that their size constrains the size of the input and output interfaces. Although present generation cellular technology limits bandwidth so much that it is not practical to download complex graphics for display, next generation cellular technology will provide sufficient bandwidth for graphics to be downloaded reasonably quickly. This will exacerbate the problems of small displays.

This problem has been addressed in various ways. For example, U.S. Pat. No. 5,797,089 (Nguyen) discloses a personal communications terminal which is operable as a personal computer, wireless telephone, and so on and which comprises two rectangular casing halves hinged together along a longer edge. The outer face of one half has a conventional cellular telephone display and controls which can be used with the device closed. The interior surface of one half carries a display and the interior surface of the other carries a keyboard, which can be used when the device is open. Even though the display occupies substantially the whole of the area of the casing, it is still relatively small.

U.S. Pat. No. 5,625,673 (Grewe et al.) discloses a modular PDA which comprises a display portion to which a mobile telephone and a keyboard can be attached. The device then becomes so large that it ceases to be a “hand-held” device and could not easily be slipped into a person's pocket.

Increasing the physical size of the display not only makes the device more bulky but also increases the power requirement of the display unit, typically a liquid crystal display or plasma panel. Increasing the power requirement is not acceptable in a portable device which operates on batteries. Moreover, such LCD screens are difficult to view where ambient light levels are high, such as in sunlight.

U.S. Pat. No. 6,073,034 (Jacobsen et al.) discloses a wireless telephone display system which, with accessories, can function as a computer. In order to provide a high-resolution image, certain specific embodiments use a microdisplay unit in a module mounted on one end of the handset, with the earpiece at the other end. The microdisplay comprises a relatively small active matrix display with optics to provide the user with a much-enlarged virtual image of the display. The resolution of the microdisplay can be switched between a first resolution suitable for a viewing distance of 6-18 inches while entering a telephone number and a second resolution suitable for a viewing distance of 1-6 inches when talking into the telephone mouthpiece. This arrangement enables a user to view the microdisplay while talking, allegedly enabling video conferencing. The usefulness of this feature is debatable, since present mobile telephone systems do not provide enough bandwidth for video conferencing. Jacobsen et al. also disclose microdisplay modules for attaching to a conventional mobile telephone, or to a card reader for reading PCMCIA cards, or even to a general purpose computer. They do not mention providing a computer processor in the mobile telephone itself, but disclose a keyboard with a touch-sensitive pad on its underside, which can be connected to a suitable socket on the mobile telephone. Absent specific description, it is presumed that the keyboard is intended to be used when the mobile telephone is being used to access a separate computer connected thereto by a suitable socket, which is one option disclosed by Jacobsen et al, Such an agglomeration of parts and connectors to be carried and assembled is unacceptable in a hand-held device. Consequently, although Jacobsen et al. avoid limiting the effective size of the mobile telephone display, as viewed by the user, they do not satisfactorily address the need for a compact, hand-held personal computer presenting to the user a high-resolution display significantly greater than the dimensions of the computer.

An object of the present invention, according to one aspect, is to mitigate the deficiencies of these known devices and to provide a hand-held computer device which, in use, displays images larger than the physical size of the device while permitting inputting of information, such as data and operational commands, by way of a user-computer interface.

A further object of the invention, according to another aspect, is to provide a mechanism whereby the portable band-held computer device can be installed in a vehicle, especially an automobile, to allow its safe and hands-free use.

### DISCLOSURE OF INVENTION

According to one aspect of the present invention, a portable personal computer device comprising a base unit, an input device on the base unit, a microdisplay unit, and a microcomputer unit for receiving signals from the input device and controlling images displayed by the microdisplay unit.

In preferred embodiments, an elongate support is pivotally attached to the base unit, the microdisplay unit being mounted upon a distal end portion of the elongate support, the support being pivotal between a closed position alongside the base unit and an open position extending away from the base unit such that, with the base unit held in one hand and the elongate support in the open position, a user may provide input via the input device while viewing an image displayed by the microdisplay unit.

The input device may comprise a touch-sensitive pad for inputting data and commands to the microcomputer unit.

The base unit may house parts of a wireless access device, for example a mobile telephone unit, and have a second display unit, preferably in said surface of the base unit. The touch-sensitive pad then may comprise an overlay upon a viewing surface of the second display unit. Means may be provided for switching the touch-sensitive pad and the microdisplay automatically on opening of the support; and vice versa.

The second display may be used to display a “soft” keypad/board when the touch-sensitive pad is in use.

The elongate support may have an opening permitting viewing of the viewing surface of the second display when the elongate support is in the closed position.

The device may have a first set of controls, e.g. keys, for use during operation of the mobile telephone unit and a second set of controls, e.g. keys and trackball, for use during operation as a computer. The first set of keys may be provided on the support so that they are accessible alongside the viewing surface of the second display when the support is in the closed position, while at least some of the keys of the second set may be so positioned that they are obscured when the support is in the closed position. Some additional controls may be provided on the base unit at such a position that they are accessible whether the device is open or closed. Such controls may serve different functions depending upon the mode of operation of the device.

Advantageously, embodiments of the present invention provide a generic hand-held computer with an integrated micro-display to allow VGA, SVGA and higher resolution quality images to be displayed. This facilitates the use of the computer as, for example, a wireless voice and data terminal, integrated personal assistant, mobile telephone, and so on.

According to another aspect of the invention there is provided, in combination, a global positioning system receiver installed in a vehicle and connected to a computer, the receiver periodically supplying to the computer data as to the position of the vehicle, the computer having software for computing from the data a current vehicle speed, comparing the current speed with a reference speed, and disabling an in-vehicle display when the current speed exceeds said reference speed.

### BRIEF DESCRIPTION OF THE DRAWINGS

The invention will be better understood and its numerous objects and advantages will become more apparent to those skilled in the art by reference to the following drawing, in conjunction with the accompanying specification in which:

FIG. 1 is a perspective view of a hand-held computer and telephone device in an open condition suitable for its use as a computer;

FIG. 2 is a perspective view of the same device in a closed condition suitable for its use as a cellular telephone;

FIG. 3 is an exploded partial perspective view of a microdisplay unit of the device;

FIG. 4 is a block schematic diagram of the electronic system of the device;

FIG. 5 is a block schematic diagram of a docking station and associated accessories permitting use of the device in a vehicle; and

FIG. 6 is a flow chart illustrating the functions performed by the hand-held during selection of a mode of operation.

### DETAILED DESCRIPTION OF PREFERRED EMBODIMENTS

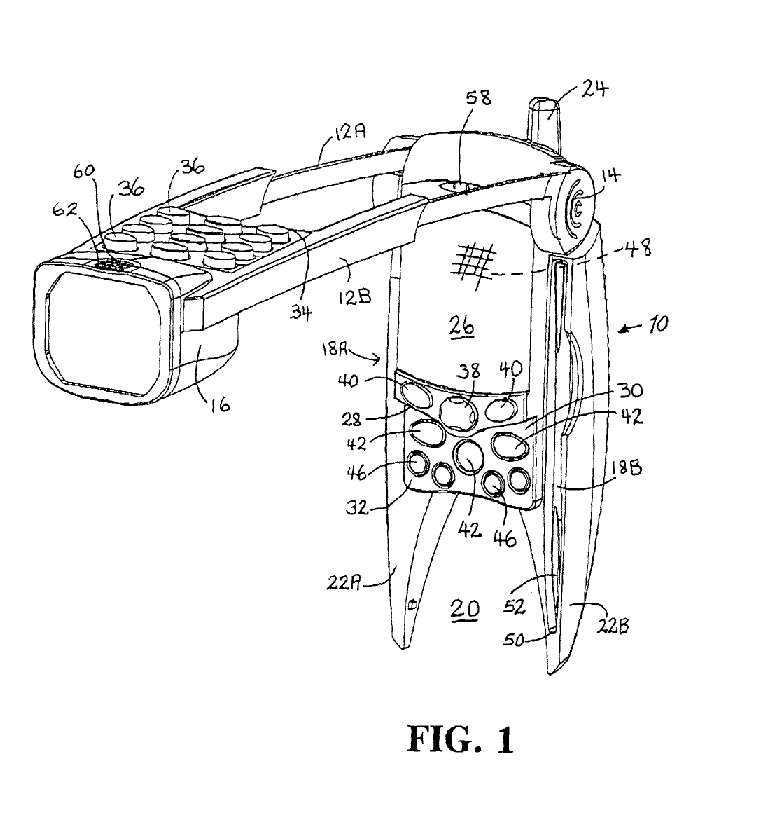

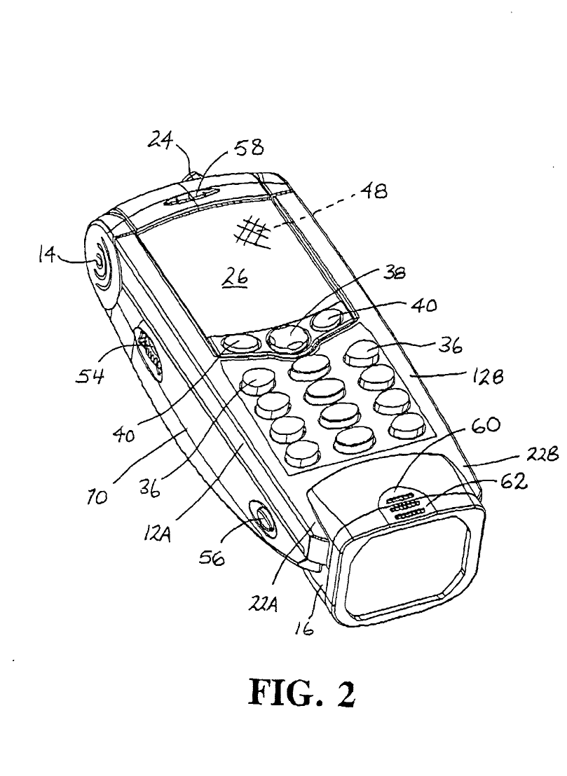

Referring to FIG. 1, a hand-held computer/telephone device comprises a base unit 10. Two arms 12A and 12B are attached to one end of the base unit 10 by a hinge assembly 14, allowing the arms to be pivoted through about 90 degrees between a first, open position and a second, closed position. The arms 12A and 12B form a support for a first display unit 16, which is attached to the distal ends of the two arms 12A and 12B. As shown in FIG. 2, when the device is closed, the arms 12A and 12B engage in slots 18A and 18B, respectively, in opposite longitudinal edges of the base unit 10. In this closed condition, the device can be used as a mobile telephone. In the open condition, the device will be used primarily as a computer (or personal digital assistant), but may be used to carry on a telephone conversation at the same time. During use as a computer, the orientation of the device will not be as shown in FIG. 1; rather the user will hold the base unit 10 in one hand with its uppermost surface generally horizontal.

The microdisplay unit 16 is mounted to the arms 12A and 12B so that a major part of its body projects to one side of the plane of the arms 12A and 12B, i.e., in FIG. 1, towards the underside of the arms 12A and 12B. When the device is closed, the projecting body part fits into an opening 20 between bifurcations 22A and 22B projecting from that end of base unit 10 which is remote from the hinge assembly 14.

The base unit 10 houses a microcomputer which is programmed with the necessary digital logic to drive the microdisplay unit 16 to generate a virtual display for viewing by a user looking onto the end of the first display unit 16. The programs and data are stored in a non-volatile memory of the microcomputer, as will be described in more detail later. The microcomputer will be activated when the device is in the open condition.

The arrangement is such that opening of the arms brings the microdisplay unit 12 close to the eyes of the user and reduces the size requirements of the optics. The characteristics of the microdisplay unit 16 and its optics will be selected so as to provide a virtual image of a suitable size, typically equivalent to the image displayed by a conventional computer monitor having a screen in the range from 9 inches to 19 inches.

The base unit 10 also houses a mobile telephone wireless unit (not shown) which serves to transmit and receive radio signals by way of an antenna 24, both to allow normal telephone calls and to allow a modem of the computer to communicate by way of a wireless telecommunications network, perhaps to access the Internet.

A second display unit 26, conveniently an LCD, is provided on the uppermost face of the base unit 10 in such a position that, when the device is closed, the second display unit 26 lies between the arms 12A and 12B. The second display unit 26 is used to display information appropriate to mobile phone usage, such as standard wireless telephone information, or name/number information stored in a database in the non-volatile memory of the microcomputer.

The uppermost surface of base unit 10 is stepped at 28 to provide a shoulder portion 30 adjacent the second display unit 26 and a recessed portion 32 between the shoulder portion 30 and the bifurcations 22A and 22B. A bridge portion 34 extends between the arms 12A and 12B near to their distal ends and form part of the casing of the first display unit 16. The bridge portion 34 is shaped so that, when the device is closed, it fits over the recessed portion 32 and its outer surface is a continuation of the surface of the shoulder portion 30, as shown in FIG. 2,

The outer surface of the bridge portion 34 carries a set of twelve keys 36 which, together with an up/down/left/right menu navigation key 38 and function keys 40 on the shoulder portion 30, can be used to operate the mobile telephone unit.

The recessed portion 32 carries a trackball 42, TAB keys 44, and four additional function keys 46. These additional controls are for use only during operation of the device as a computer unit and so are obscured by the bridge portion 34 when the device is closed. The navigation key 38 and function keys 40 may be used during computer operation as well as during mobile telephone usage, and may serve different functions in the computer mode. In addition, a touch-sensitive pad 48 provided as an overlay upon the second display unit 26 serves as an additional input device for the microcomputer unit. A slot 50 in the bifurcation 22B houses a stylus 52 for use with the touch-sensitive pad 48.

When the device is being used in the open condition, as a computer, the LCD display unit 26 is deactivated and the touch-sensitive pad 48 is activated. When the device is being used in the closed condition, as a mobile telephone, the LCD display 26 is activated and the touch-sensitive pad 48 is deactivated. The switching on and off of the second display unit 26 and the touch-sensitive pad 48 may be done automatically by a switch, conveniently in hinge 14, operable by opening and closing of the device.

A trackwheel 54 may be provided in the side of base unit 10 and used to allow navigation through menu items when the (closed) mobile telephone unit is being used, facilitating one-handed operation. The track wheel 54 may also be used in the open position to conveniently browse longer documents and webpages.

A spring-loaded catch 56 on the bifurcation 22A engages a notch (not shown) in the side of the body portion of the display unit 16 to lock the device in the closed position.

A microphone 58 is provided at the end of the microdisplay unit 16 and a speaker 60 is provided on the base unit 10, at a position adjacent the hinge assembly 14. Hence, when the device is closed, the microphone 56 and speaker 58 are positioned at opposite ends of the device, as in a conventional mobile telephone. A user may talk on the mobile telephone while using the device as a microcomputer, in which case both parts of the device will be turned on and enabled.

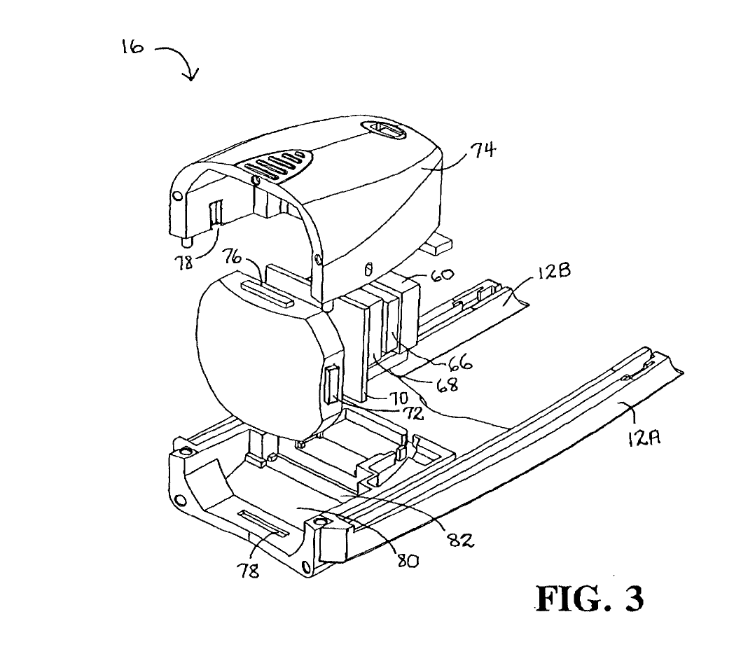

Referring now to FIG. 3, the main components of the microdisplay unit 16 comprise, in succession, a backlight 64 (such as a LED), a display chip 66, a first lens 68, a Fresnel lens 70 and an eyepiece lens 72; all housed in a casing part 74 which clips to the bridge portion 34. Lugs 76 projecting from the edges of the eyepiece lens 72 engage in grooves 76 in the bridge portion 34 and the casing 74 to support and locate the eyepiece lens 72. Recesses 80 and 82 and an inclined surface 84 in the bridge portion 34, and corresponding formations in the casing 74, serve to support and locate the Presnel lens 70, lens 68, display chip 66 and backlight 64. The backlight 64 may be a light emitting diode (LED). The microdisplay unit 16 will not be described in more detail since such components are known. Suitable microdisplay units are marketed by Kopin Corporation of Taunton MA under the trade mark CyberDisplay.

Thus, to use the device as a computer or personal digital assistant, the user will hold the base unit 10 in one hand, with the arms 12A, 12B open and the microdisplay unit 16 directed upwards towards the user's eyes, and use the stylus 52 in the other hand to make entries via the touch-sensitive pad 26 or the various other controls. Typically, the device will be held so that the microdisplay unit 16 is 2.75-4.25 inches from the eye of the user, which will leave sufficient space for comfortable access to the touch-sensitive pad 26, the trackball 42 and the various function control keys.

The microdisplay unit 16 may be monocular or binocular. If monocular optics are used, the microdisplay unit may be smaller. The effective focal length may be selected so that the virtual image is focused at whatever position is appropriate for a specific implementation; typically anywhere from 2 feet to 5 feet. Depending upon specific implementations and requirements, the size of the image could be anywhere from 6 inches to 19 inches diagonally. In one practical embodiment, the display unit provided a virtual image measuring about 11 inches diagonally and positioned at about 25 inches from the user's eye.

The input to the microcomputer unit may be effected using one or more mechanisms; (i) using the touch-sensitive pad 48 and hand-writing recognition software running in the microcomputer unit; (ii) using a soft key pad; a small keyboard displayed on the keypad denoting keyboard keys; (iii) using the trackball; (iv) using the provided the second display unit 26, the touch-sensitive pad 48 then serving as a keypad. Obviously, use of such a soft keypad would require the second display unit 26, touch-sensitive pad 48 and the microdisplay unit 16 to be energized at the same time. It is also envisaged that an ASCII keyboard could be connected to the device using a suitable interface. The user can use the trackball 42 to drag a cursor in the display to make selections. In either the mobile telephone mode or the computer mode, the user can use the up/down/left/right navigation key 38 to navigate around a main menu.

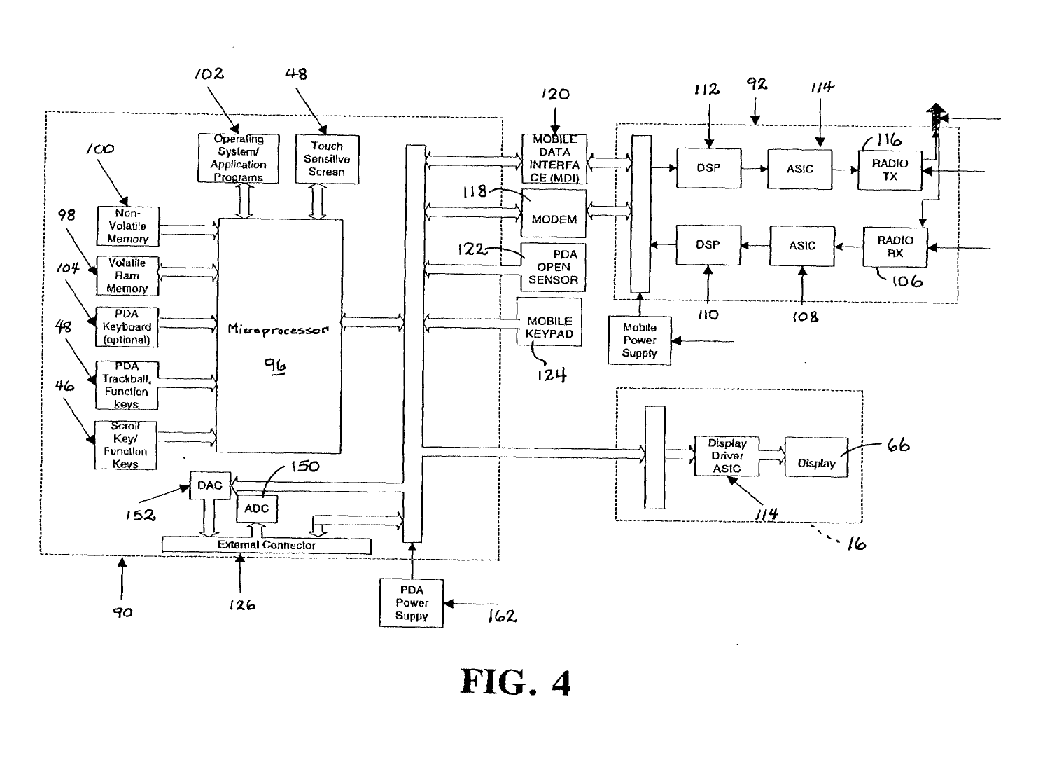

FIG. 4 is a high-level block diagram illustrating schematically the electrical components of the hand-held device 90, the mobile unit 92 and the microdisplay drive unit 94. The portable hand-held computer/telephone has two power supply units; one for supplying the computer unit and the other for supplying the mobile telephone circuitry. The wireless access circuitry will, of course, need to be energized when the computer modem is being used. A power switch 64 located on one side of the base unit 10 may be used to switch the microcomputer unit and the mobile telephone unit ON or OFF independently of each other. (Separate ON/OFF switches could be provided for the microcomputer unit and the mobile telephone circuitry, respectively.) Power to supply the computing device is provided by a battery 162 (see FIG. 4) which is clipped to the outer or rear surface of the base unit 10.

In the display unit 16, a display driver 114 in the form of another ASIC receives the image information from the microcomputer unit 90 and converts the data into necessary signals to drive the display chip 66. The display unit is considered as a separate unit since this unit can be functionally replaced by another display unit as it is done in the preferred embodiment when used in an automobile. In another embodiment, the display unit can be attached to the glasses of the user, using a design that is known in the art. The microcomputer unit 90 and the mobile unit 92 are interfaced through a Mobile Data Interface (MDI) 120. The microcomputer unit sends control commands and data through the MDI 120. A MODEM unit 118 is used for sending and receiving of data by the microcomputer unit 90 via the mobile unit 92.

The microcomputer unit 90 comprises conventional components, namely Microprocessor 96, Random Access Memory (RAM) 98, Read Only Memory (ROM) or Flash Memory 100, and operating system software and application software 102, such as word dprocessor, spreadsheet, database and organizer programmes, together with global-positioning system software if the device is to be used in a vehicle equipped with a global-positioning system as will be described later. FIG. 4 also shows the various interfaces for the input devices, namely touch sensitive screen 48, optional keyboard 104, trackball 42, function keys 46, scroll keys, microphone 60, and speaker 58. Different combinations of such components are available in existing personal digital assistants so their construction is known to those skilled in the art. The mobile unit 92 also is of a kind known to those skilled in the art, and comprises an antenna 24 to receive and transmit radio waves. The radio waves from the antenna 24 are received by the Radio receiver unit 106 and processed by the Receiver ASIC (Application Specific Integrated Circuit) 108 and the DSP 110. The information received may be converted into voice signals and fed to the speakers 58,62. Voice signals from the microphone 60 are converted to digital signals by appropriate electronic components (not shown) and supplied to a transmitter section which comprises a DSP 112, ASIC 114 and radio transmitter 116, transmits them via the antenna 24 to the base station (not shown).

The radio transmitter section also converts signals received from the microcomputer unit 90 by way of the modem 118.

A PDA “open” sensor 122 detects whether the device is open or closed and supplies the information to the microprocessor 96. Signals from the mobile telephone keypad controls 36 are supplied to the microprocessor 96 via an interface 124.

Presently, it is known to provide “Telematic” equipment in a vehicle, which provide GPS (Global Positioning System) and personal digital assistant related functionality to the driver of the vehicle. These systems have a number of disadvantages. They are integral parts of the vehicle, however, and cannot be detached and used outside the vehicle. Moreover, the user has another piece of electronic equipment to learn, train and maintain. Finally, the database in the equipment has to be synchronized with other databases in the portable, personal computer.

Embodiments of the present invention can be connected to the automobile using optional accessories and can be used hands-free in the automobile. Thus, a connector 126, shown as part of the microcomputer unit 90, allows connection of the portable hand-held device to a docking station in an automobile.

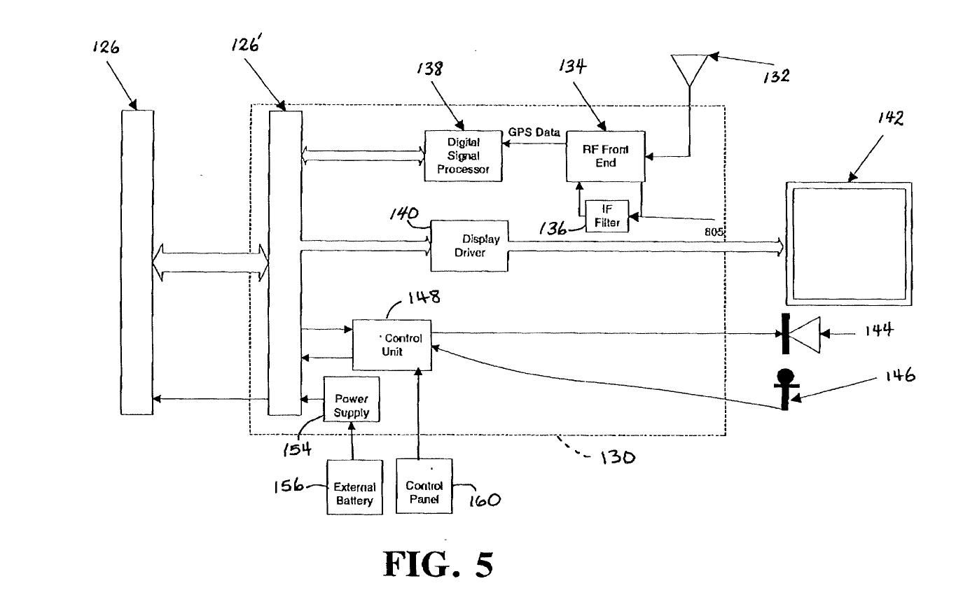

FIG. 5, which is a high-level block diagram of the components of the docking station and the related accessories, shows the connector 126 connected to a complementary connector 126′ of the docking station unit 130. The docking station is shown as comprising a GPS unit, having an antenna 132, an RF Front End unit 134 with an Intermediate Frequency (IF) filter 136 and a GPS digital signal processor 138. When connected to the docking station, the portable computer device provides the microprocessor 96, the RAM 98 and the ROM 100. The GPS processing software and map viewing software is preloaded into the microcomputer unit 90 and becomes active as soon as the portable device is inserted into the docking station 130 and is turned ON.

The docking station 130 is depicted with a separate display driver 140 which drives a separate display 142. When the hand-held computer device is used with the docking station 130, the microcomputer unit 90 will not use its own display driver 114 but instead will operate the docking station display driver 140 by way of the connector 126 to control the display 142.

FIG. 5 shows a separate loudspeaker 144 and a separate microphone 146 both connected to a control unit 148 of the docking station 130. The control unit 148 relays voice signals from the microphone 146 by way of the connectors 126/126′ and an analog-to-digital converter 150 (FIG. 4) to the microprocessor 96. The control unit 148 also relays to the speaker 144 audio signals received from a digital-to-analog converter 152 in the microcomputer unit 90, via connectors 126, 126′. A voice recognition software module may be provided in the hand-held computer and used to monitor verbal utterances from the microphone 146 through the connectors 126, 126′. The audio output is passed from the text-to-speech software via a digital-to-analog (DAC) converter 152 (FIG. 4) to the speaker 144 in the vehicle. The docking station 130 has a power supply unit 154 which obtains the power from the vehicle's power supply (shown as an external battery 156) and provides regulated power to both the hand-held device and the docking station 130. It also has a control panel 160 having controls for operating the GPS docking station and its accessories, for example to adjust the speaker volume or the display unit 142, or the GPS receiver.

The connector 126, 126′ may be, for example, PCMCIA or USB connectors. While attached to the docking station in a vehicle, both the microcomputer unit 90 and the mobile telephone unit 92 (FIG. 4) derive power from the power supply 154 in the docking station 130. The docking station 130 connects them to the voice-input device i.e. microphone 146, voice output device i.e. speaker 144 and the display device 142, can be attached to a convenient spot in the automobile.

Once connected, the portable unit (both the microcomputer unit 90 and the mobile telephone unit 92 can be used hands-free using voice commands. The display from the hand-held unit is displayed on the display 142 in the automobile. Since voice recognition technology available at present is error prone, a visual indication aids in navigation through the programs. The GPS circuitry (803, 804, 805), allows the GPS program running on the microcomputer unit 90 of the portable hand-held computer device to generate moving graphs and also provide voice prompts to the user.

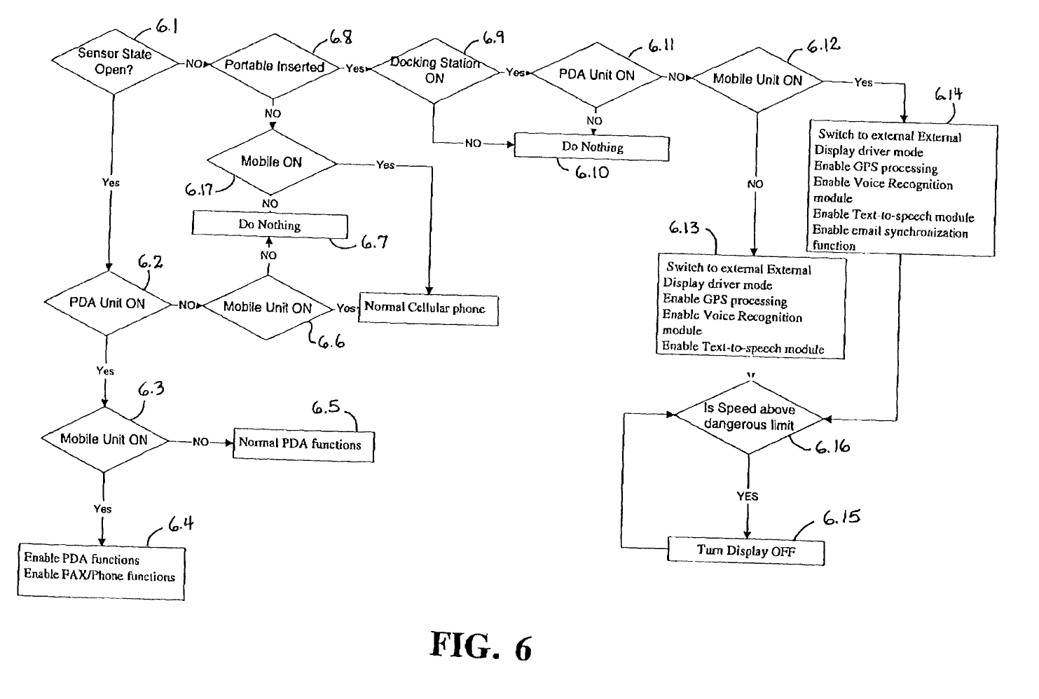

FIG. 6 is a flow chart illustrating the functions performed by the hand-held computer device during selection of a mode of operation. There are a number of different inputs to the device, which decide the state of operation of the device. The process starts with checking the state of the “PDA open” sensor state (6.1). If the sensor is in the “open state” the program checks (7.2) if the PDA unit is switched ON. If it is, then the state of the mobile telephone unit is checked (9.3). If the mobile telephone unit is ON all the functions (6.4) related to the microcomputer unit 90 and the mobile telephone unit 92 are available. If the mobile is OFF the device behaves like a regular microcomputer unit (6.5) If the Microcomputer unit is not ON, but the Mobile telephone unit is ON (6.6) the device behaves like a normal mobile telephone. If both the microcomputer unit and the mobile unit are OFF, then the device does nothing 6.7).

If the Sensor State step (6.1) indicates that the portable device is closed, the program determine (6.8) whether or not the device is inserted into the docking station 130. If it is, then the program determines whether or not the docking station is ON (6.9). If the docking station is not ON, then the device is not available for any service (6.10). If the docking station is ON, but the microcomputer unit is not ON (6. 11), the device is still not available for any service (6.10). The reason for not providing any service is that the processing power of the microcomputer unit is used for hands-free use of the hand-held portable in the automobile. If the microcomputer unit is ON, a check (6.12) is made to see if the mobile telephone unit also is ON. In either case, i.e. whether the telephone unit is ON or OFF, the microcomputer unit 90 switches (6,13, 6.14) to driving the external display 142, enables the GPS functionality to monitor the movement of the vehicle and enables the Voice Recognition and speech-to-text modules. These modules allow hands-free use of the device. Since use of the device in the automobile can be dangerous if travelling at high speeds, the display device is turned OFF (6.5) at speeds above the programmable speed limits and is turned ON automatically below the speed limits. The microcomputer unit 90 uses data from the GPS unit to calculate the speed at which a vehicle is moving, i.e. by calculating the distance travelled for given period of time (6.16). The speed above which the display is turned OFF is programmable and can be set anywhere from 0 to 80 mps.

If step 6.8 shows that the device is not in the docking station 130 and is the closed position, a check is made (6.17) to determine whether or not the mobile unit is ON. If the mobile unit it ON, the portable hand-held provides the functionality of a mobile phone (6.18); else no functionality is provided (6.7). It should be noted that, when the device is in the closed position, the state of the microcomputer unit is not checked, since the latter cannot be used in that state.

Thus, when the hand-held computer is connected to the docking station 130 in the closed form, it acts as a processing unit and a unit for wireless voice and data. The microcomputer unit 90 processes user input, which may be done using the voice data received from the docking station; processes the positional information received from the GPS electronics (134, 136, 138) present in the docking station 130; drives the display 142 connected to the docking station 130 and feeds voice data to docking station unit 130 to drive the speaker 144.

The display unit may comprise any LCD or micro-display based units. Those skilled in the micro-display art would be able to design such optics. When a user wants to perform a task, the user commands by speaking to the microphone. The voice is received by the personal digital assistant unit through the docking station and is processed by the voice recognition module running on the PDA unit. The voice commands are processed which is similar to the command been entered from a keyboard or from a mouse device. Once the command is processed the processor drives the display driver logic present on the docking station which ultimately drives the display unit. A user can instruct the user for example to Read Email. Once the verbal utterances are understood by the voice recognition module, the text provided in the email can be read out using the text-to-speech technology. Text-to-speech module converts the text into voice signals, which can be used to drive the voice output device connected to the connector. This way email etc. can be read out to a user. The system can, for example, provide visual and audio navigational guidance to the user. The personal digital assistant processes the positional information received from the docking station and generates visual and audio navigational guidance to the user.

It is envisaged that any other device with capabilities similar to the portable hand-held unit and with an interface compatible with the connector 126′ on the docking station, and containing the related display driver, voice recognition and text-to-speech software, can benefit from this aspect of the invention. This enables commercially available hand-held PCs to be converted to useful telematics equipment without the investment being tied up in the automobile.

As described with reference to FIG. 3, the microdisplay unit 16 comprises a micro-display chip 66, an illumination system 60 and optics 68,70,72. There are a number of trade-offs to be considered while designing the display unit. Some of the different choices are:

The micro-display chip 66. There are a number of displays available commercially.

The eye relief i.e. the distance between the optics and the eye. If the eye relief is reduced then the usability of the device goes down. Increasing the eye relief requires larger optics, hence required the size of the device to increase.

The Field of View (FOV). The FOV determines the size of the virtual image. If the FOV is made larger, then larger size optics are required and more magnification is required from the optical lens. If the FOV is made smaller, then a smaller display is available to the user.

Exit Pupil - Is the imaginary circle within which the virtual display is visible to the eye. If the exit pupil is made larger, then the size of the display must become larger. If the exit pupil is made smaller, then usability of the PDA is reduced.

Monocular/Binocular optics - Binocular optics likely would be too large to be integrated into a hand-held device; hence a monocular optics are used in the preferred embodiment.

In one of the embodiments, the following specifications were used for the optics.

Eye-Relief: 4.00

Field of View: 13 degrees for half diagonal

Exit Pupil: 12 mm

The display unit 16 is considered as a separate unit since this unit can be functionally replaced by another display unit, for example, when used in an automobile. It is also envisaged that the display unit could be attached to the glasses of the user as is known in the prior art.

An advantage of embodiments of the invention wherein the computer device is adapted for connection to a docking station in a vehicle is that the same portable hand-held computer device can be used in the office, at home, at the airport, etc. and can be used while driving. A user has to learn to use, train and maintain only one device.

It should be noted that the invention also embraces the use of a docking station in combination with a computer device other than that described herein with reference to FIGS. 1 to 3. The docking station concept, with monitoring of vehicle speed and disabling of a display, could be implemented with a conventional laptop computer, for example.

It should be appreciated that the microdisplay chip 66 could be of the transmissive or reflective kind.

In embodiments of this invention, the use of a microdisplay mounted upon an arm which can be pivoted away from an input device, such as a touch-sensitive pad or keyboard, removes the constraints placed upon the size of the display by the size of the device.

It should be noted that, in contrast to the device disclosed in U.S. Pat. No. 6,073,034, in which the microdisplay displays data received over the wireless network, in preferred embodiments of the present invention, the microdisplay unit displays data from the microcomputer unit, i.e. in its stand-alone computer mode. Hence, even if the device receives data via its modem and the mobile telephone unit, it will be displayed as a conventional computer image rather than as a mobile telephone display. Only the second display unit 26 is used to display normal mobile telephone information.

### INDUSTRIAL APPLICABILITY

Although an embodiment of the invention has been described and illustrated in detail, it is to be clearly understood that the same is by way of illustration and example only and not to be taken by way of the limitation, the spirit and scope of the present invention being limited only by the appended claims.

1. A portable personal computer device comprising:
a base unit (10);
an input device (38-48) on the base unit;
a microdisplay unit (16); and
a microcomputer unit (90) for receiving signals from the input device and controlling images displayed by the microdisplay unit.

2. A device according to claim 1, further comprising an elongate support (12A,12B,34) pivotally attached to the base unit, the microdisplay unit being mounted upon a distal end portion of the elongate support, the support being pivotal between a closed position alongside the base unit and an open position extending away from the base unit such that, with the base unit held in one hand and the elongate support in the open position, a user may provide input via the input device while viewing an image displayed by the microdisplay unit.

3. A device according to claim 1, wherein the input device comprises a touch-sensitive pad (48) for inputting data and commands to the microcomputer unit.

4. A device according to claim 2, wherein the base unit houses parts of a wireless access device (92) and a second display unit (26) is provided on said base unit, the second display being viewable when the support is in the closed position.

5. A device according to claim 4, wherein the input device comprises a touch-sensitive pad (48) overlying a viewing surface of the second display unit (26).

6. A device according to claim 5, further comprising switch means for switching the the touch-sensitive pad (48) and the microdisplay (16) on when the device is opened.

7. A device according to claim 6, wherein the switch means is operable automatically in dependence upon opening and closing of the support.

8. A device according to claim 4, wherein the support has an opening through which the second display (26) is visible when the support is in the closed position.

9. A device according to claim 4, wherein the input device comprises a set of controls (42) for operation of the microcomputer unit, a second set of controls (36) for operation of mobile telephone unit being provided on a part (34) of the support (12A, 12B,34) so as to be accessible alongside the viewing surface of the second display (26) when the support is in the closed position, at least some of the first set of controls being so positioned as to be obscured by the support when the support is in the closed position.

10. In combination, a device according to claim 1, means (126,126′) for connecting the device to a docking unit (130) in a vehicle and means for providing data related to vehicle location (132,134,136) and supplying said data to the microcomputer unit (90), the microcomputer unit having software for operation of the combination as a navigational system.

11. A combination according to claim 9, wherein a separate display is provided in the vehicle and connected to the microcomputer unit via the connecting means, and the microcomputer unit is operable to disable said separate display when vehicle speed exceeds a predetermined speed.

12. In combination, a global positioning system receiver installed in a vehicle and connected to a computer, the receiver periodically supplying to the computer data as to the position of the vehicle, the computer having software for computing from the data a current vehicle speed, comparing the current speed with a reference speed, and disabling an in-vehicle display when the current speed exceeds said reference speed.

13. A computer device according to claim 1, having an interface for connection to a global positioning system receiver and software for computing from data supplied by the a current vehicle speed, comparing the current speed with a reference speed, and disabling an in-vehicle display when the current speed exceeds said reference speed.
